(19) United States
(12) Patent Application Publication
(10) Pub. No.: US 2014/0041506 A1
(43) Pub. Date: Feb. 13, 2014

(54) Coated Musical Instrument String

(71) Applicant: Terry Jones, Castro Valley, CA (US)

(72) Inventor: Terry Jones, Castro Valley, CA (US)

(21) Appl. No.: 13/960,790

(22) Filed: Aug. 6, 2013

Related U.S. Application Data
(60) Provisional application No. 61/680,374, filed on Aug. 7, 2012.

(51) Int. Cl. G10D 3/10

(52) U.S. Cl. CPC G10D 3/10
USPC 84/297 S; 427/434.6; 427/372.2; 427/331; 427/431; 427/177

(57) ABSTRACT

Disclosed is a method for making a coated musical instrument string comprising plating a musical instrument string in a composite electroless plating bath at a specified bath temperature for a specified bath time to create a coated musical instrument string to create wound musical instrument string. The musical instrument string may be plain wire or wound wire made of copper and or steel alloys. The composite electroless plating bath comprises nickel, cobalt, polytetrafluoroethylene (PTFE) and/or diamond. Other embodiments are disclosed.

### CROSS-REFERENCE TO RELATED APPLICATIONS

This application claims the benefit of priority of U.S. Provisional Patent Application 61/680374 filed Aug. 7, 2012 and titled “MUSICAL INSTRUMENT STRING,” the disclosure of which is incorporated by reference.

### BACKGROUND OF THE INVENTION

1. Field of Invention

The invention relates generally to the field of strings for musical instruments, and specifically to strings for guitars and related musical instruments.

2. Description of Related Art

Music is among the most important aspects of a culture. There are a number of different types of musical string instruments in use today, including the guitar, violin, cello, bass, banjo, piano, harp strings, mandolin, etc. New strings produce solid, rich tones that can revive old culture and enhance relationships.

Historically, musical instrument strings were a single strand of an organic material or metal (wire). While some strings instruments are played with bows or a hammer, and do not routinely contact skin oils and perspiration, other musical instrument strings are plucked or fingered and subjected to skin oils and perspiration, which can cause surface degradation and oxidation, and galvanic corrosion, causing tonal distortions. Furthermore, friction between strings and frets causes fret wear, damaging the instrument.

The reality, however, is that all musical instrument strings are subject to deterioration from many causes. The mechanics of securing the string to the instrument and tuning the string stretches (strains) the string. Playing the instrument adds minor strain, but environmental factors such as humidity, pollution, sweat and body oils, skin contaminants and aging, accelerate surface corrosion and deterioration of the string. Repeated strain and surface corrosion causes micro-fractures in the strings, which allows air permeation, contaminate infiltration and oxidation, which change the tone of the affected strings.

In some instances, exotic materials have been tried to engineer around the problems. These materials, however, can be expensive, less than effective, and not feasible for many people.

Wound strings comprise a core wire, and strands of the same material or another material wound around the core. The composition and dimensions of the core and the windings are chosen to produce the desired tones when the string is caused to vibrate.

While plain (non-wound) gage strings can be wiped of dirt and oil after use to mitigate contaminates, wound strings tend to stay contaminated with dirt, skin oils, and perspiration after even a few hours of playing. When dirt and other contaminants infiltrate the windings of the string, corrosion, galvanic coupling, and other degradation processes further distort the strings' characteristic sounds.

Furthermore, technical advances with acoustic instruments and electronic string instruments greatly increase the performance requirement on musical instrument strings. Typical coatings, however, reduce the strings performance by reducing its magnetic saturation and permeability. Also, oxidation (corrosion) of the wrap wire from human and environmental contact at both the raw material stage and in finished product use may cause the strings to suffer further contamination issues as well as friction between the windings causing tonal degradation.

To mitigate these problems with wound strings, various coatings and plating processes have been used. Most coatings and plating processes, however, only slow down the degradation process, are less than effective, or even degrade and become part of the problem. In other instances, the expense of the technology string outweighs the benefit. In addition, strings with stainless steel wrap wire are considerable more abrasive, and damage the frets or other contact areas of the musical instrument.

Collectively, these strains, (literally and figuratively) can so greatly decrease the life of some strings that tonal distortion is severe in two weeks, or in less time with frequent performances. At this point, the string is musically “dead” and the musician is forced to deal with the tone change. To maintain the proper tone, strings have to be cleaned and periodically tuned, which for instruments with many strings, can take a long time. Not all strings, however, can feasibly be cleaned. Some cleaning methods are impossible with installed strings. Some cleaners, if used at all, must be used with caution as they may leave behind a residue that affects the sound of the string, or worse case, contribute to an inconvenient and awkward break of the string during a performance.

Consequently, “dead” strings are frequently removed from the instrument and replaced. Though the process is burdensome, time consuming, and expensive, it is the best, if not sole remedy for musicians who require high tonal quality and play frequently. Disposal of the dead strings also represents a waste of resources. Hence, preventing degradation and tonal distortion are greatly preferred.

### SUMMARY OF THE INVENTION

Disclosed is a method of preserving and improving the tonal quality of musical instrument strings with the application of a composite electroless plating (i.e., a process to apply a coating) applied to a musical instrument string. The plating process comprises electrolessly plating a surface with a metal or alloy coating that contains dispersed particulate matter. The composite electroless plating bath typically comprising a metal salt, an electroless reducing agent, a complexing agent, an electroless plating stabilizer, a quantity of particulate matter which is essentially insoluble or sparingly soluble in the composite electroless plating bath, and a particulate matter stabilizer. The particulate matter is kept in suspension in the composite electroless plating bath during the composite electroless plating of the musical instrument string for a time sufficient to produce a metallic coating with particulate matter dispersed within the coating.

The method disclosed is based on U.S. Pat. No. 8,147,601 B2 for Composite Electroless Plating to Feldstein et al. assigned to Surface Technology, Inc. of Robbinsville, N.J. with additional technology.

### BRIEF DESCRIPTION OF THE DRAWINGS

FIG. 1 shows a method for making a coated musical instrument string of either plain or wound wire.

FIG. 2 shows a method for making a coated wound musical instrument string.

### DETAILED DESCRIPTION OF THE INVENTION

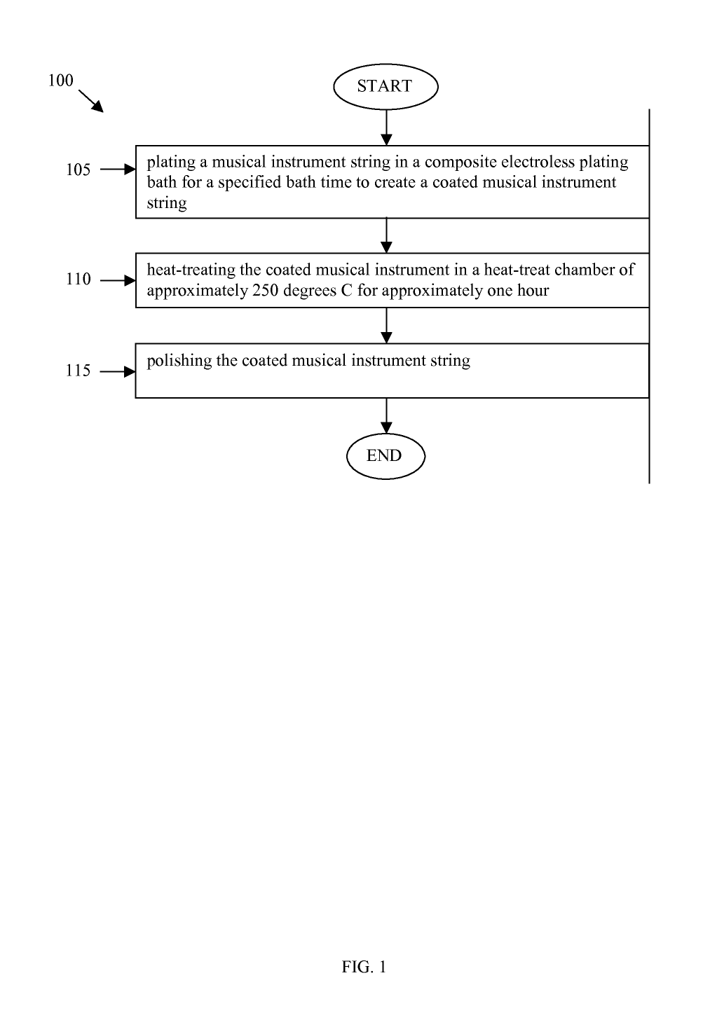

FIG. 1 shows a method for making a coated musical instrument string of either plain or wound wire. The articles to be metallized were pretreated (e.g., cleaning, strike, etc.) prior to the actual deposition step. In some embodiments, the musical instrument string comprises a copper alloy. The copper alloy may be bronze. In some embodiments, the musical instrument string comprises a steel alloy. The steel alloy may be nickel plated prior to metallization according to the present invention. In some embodiments, the musical instrument string is wound steel alloy, or wound copper alloy. The core wire may be plated with tin or another metal.

Step 105 comprises plating at least a portion of a musical instrument string in a composite electroless plating bath for a specified bath time to create a coated musical instrument string. In some embodiments, the whole of the musical instrument string undergoes the plating bath. In some embodiments, only a portion of the string may be coated.

In some embodiments, the musical instrument string comprises a plain wire selected from the group consisting of a copper alloy and a steel alloy. In some embodiments, the musical instrument string comprises a wound musical instrument string. In some embodiments, the musical instrument string comprises a core steel wire. In some embodiments, the musical instrument string comprises a wrap wire selected from the group consisting of a copper alloy and a steel alloy.

In some embodiments, the composite electroless plating bath comprises ultra-fine polytetrafluoroethylene (PTFE), nickel, and/or cobalt in a formulation designed to deposit a uniform composite with ultra-fine PTFE at an exceptionally high plating rate. The formulation is available as NiSlip 595 from Surface Technology, Inc. of Robbinsville, N.J. In plating applications, the metal or alloy matrix may be applied through an electroless, electrolytic or other methods. The coating may be alloyed with additional materials such as phosphorous and/or boron, in various percentages as desired for the application. The metals or alloy may be selected from suitable metals capable of being deposited, including, without limitation, nickel, cobalt, copper, gold, palladium, iron, other transition metals, and mixtures thereof, and any of the metals deposited by the autocatalytic process in Pearlstein, F., “Modern Electroplating”, Ch. 31, 3^{rd} Ed., John Wiley & Sons, Inc. (1974), which is incorporated herein by reference. Preferably, the metals are nickel, cobalt and copper.

The ultra-fine polytetrafluoroethylene (PTFE) “lubricates” the surface of the musical instrument string and lessens the fret wear. Other low friction materials are further contemplated within the context of this invention, including but not limited to PFA, MFA, PEEK, PEK and other fluoropolymer or silicone materials.

The inclusion of nickel increases the corrosion resistance and other properties of the musical instrument string. The inclusion of cobalt increases the effect (magnetic permeability and magnetic saturation) of a musical instrument string with magnetic pickups (microphones), thereby increasing the instrument's output and giving the string a wider dynamic range, and other properties.

When used in the preferred operating conditions, the temperature of the composite electroless plating bath is specified in the range of 88 degrees C. to 92 degrees C. (190 degrees F. to 198 degrees F.). The optimum temperature of the composite electroless plating bath is 90 degrees C. (194 degrees F.).

In this embodiment, the composite electroless plating bath has a pH in the range of 5.8 to 6.3 and is optimally at 6.1. Bath loading is in the range of 0.3 to 0.7 square feet per gallon, and is optimally at 0.5 square feet per gallon. The nickel metal concentration of the composite electroless plating bath is in the range of 0.65 to 0.85 ounces per gallon and has an optimal concentration of 0.8 ounces per gallon. The H₂PO₂ concentration in the range of 3.5-4.5 ounces per gallon, optimally at 4.0 ounces per gallon. The ultra-fine PTFE concentration was approximately 20% to 25%% by weight. The musical instrument strings are immersed in the bath for a specified time of about 20 minutes to achieve a coating thickness between 0.2 to 0.3 mils.

Generally, the rate of coating deposition exceeds 10 microns per hour. In some embodiments, the rate of coating deposition is about 15-20 microns per hour. Use of other composite electroless plating baths at other plating rates is considered within the context of the present invention.

In some embodiments, the composite electroless plating bath comprises ultra-fine diamond particles, nickel and/or cobalt in a formulation designed to deposit a uniform composite with ultra-fine diamond particles onto the musical instrument strings. In some embodiments, the ultra-fine round diamond and a phosphorous content is approximately 1% to 4% by weight.

The ultra-fine round diamond reduces the static and dynamic friction of the surface of the coated musical instrument string and provides exceptional wear resistance of the coated musical instrument string. The formulation is commercially available under the registered trademark COMPOSITE DIAMOND COATING from Surface Technology, Inc. of Robbinsville, N.J. Other hard materials are further contemplated within the context of this invention.

Additional types of particulate matter may be selected from a wide variety of distinct matter, such as ceramics, glass, talcum, plastics, diamond (polycrystalline or monocrystalline types), graphite, oxides, silicides, carbonate, carbides, sulfides, phosphate, boride, silicates, oxalates, nitrides, fluorides of various metals, as well as metal or alloys of boron, tantalum, stainless steel, molybdenum, vanadium, zirconium, titanium and tungsten. Without limitation, preferred specific examples of particulate matter for use in the present invention are polytetrafluoroethylene (PTFE), diamond, silicon carbide, boron nitride (BN), aluminum oxide, graphite fluoride, tungsten carbide, talc, molybdenum disulfide (MoS), boron carbide and graphite. The boron nitride (BN), without limitation, may be hexagonal or cubic in orientation.

When used in the preferred operating conditions, the temperature of the composite electroless plating bath is specified in the range of 70 degrees C. to 80 degrees C. (156 degrees F. to 176 degrees F.). The optimum temperature of the composite electroless plating bath is 77 degrees C. (167 degrees F.). In some embodiments, the specified bath time runs for about 20 minutes to achieve a coating thickness between 0.2 to 0.3 mils. In other embodiments, the specified bath time may range from approximately 15 to 50 minutes.

In this embodiment, the composite electroless plating bath has a pH in the range of 5.7 to 6.6 and is optimally at 6.3. Bath loading in the range of in the range of 0.3 to 0.8 square feet per gallon, and is optimally at 0.5 square feet per gallon. The nickel metal concentration range is 0.65 to 0.85 ounces per gallon, with an optimum concentration of 0.8 ounces per gallon. The H₂PO₂ concentration in the range of 3.5-4.5 ounces per gallon, optimally at 4.0 ounces per gallon.

In some embodiments, the rate of coating deposition is about 0.7 to 0.9 mil per hour (17.78 microns to 22.86 microns per hour).

In some embodiments, the rate of coating deposition is about 0.6 to 0.8 mil per hour (15.24 microns to 20.32 microns).

In some embodiments, the composite electroless plating bath comprises ultra-fine polytetrafluoroethylene (PTFE), nickel, diamond, and cobalt. This hybrid solution has the benefit of the PTFE lubricity and exceptional wear resistance of the diamond.

Step 110 comprises heat-treating at least the portion of the coated musical instrument string in a heat-treat chamber of approximately 250 degrees C. for approximately one hour. The benefits of Hi-temperature post processing for non-coated wire is described in U.S. Pat. No. 4,063,674 to Stone, and are realized here as a benefit of post treatment for the electroless composite coating as well. If the core wire is tin-coated, this provides improved adhesion of the coating, better cohesion of the matrix and particles, precipitation hardening of the surface, bonding of the core wire to the wrap wire due to the tin coating of the core wire melting and effectively soldering the wrap wire to the core, and improvement of wrap wire spacing due to the expansion of the wrap wire at this temperature.

After heat treatment, the musical instrument string plated using the composite electroless plating bath comprising the composite ultra-fine polytetrafluoroethylene formulation has the following properties in some embodiments:

| | |
|---|---|
| Coefficient of Static Friction | 0.1 |
| Coefficient of Dynamic Friction | 0.08-0.10 |
| PTFE Content | 20-25% by volume |
| Phosphorus Content | 7-9% by wt. |
| Hardness as plated | 300 VHN100 |
| Hardness as heat treated @ 250° C. for 1 hr. | 450 to 500 VHN100 |
| Stress | almost none |
| Magnetic Properties | slightly magnetic |

After heat treatment, the musical instrument string plated using the composite electroless plating bath comprising the ultra-fine round diamond formulation has the following properties in some embodiments:

| | |
|---|---|
| Diamond Content | Up to 10% |
| Phosphorous Content | 1-4% by wt. |
| Hardness as plated | 850 VHN100+ |
| Hardness as heat treated @ 250° C. for 1 hr. | 1150 VHN100+ |
| Stress | slightly tensile |
| Magnetic Properties | slightly magnetic |

Post treatment inspection showed that adhesion of the coatings, as well as durability were as expected. Abrasion tests were performed using 3M Tri-M-ite 320 grit sand paper. The composite ultra-fine polytetrafluoroethylene formulation showed signs of base material after the 3rd pass. The ultra-fine round diamond formulation showed signs of base material after the 12th pass. These results compared favorably to competitive polymer coatings which all showed base material after the first pass.

If the core wire was tin-coated, then core bonding to wrap wire was complete as expected due to the post deposition heat treatment process, a benefit as described in U.S. Pat. No. 4,063,674 to Stone.

Surface characteristics were as expected. The strings plated with the PTFE formulation provided a very smooth feel with reduced string “squeak” when played, due to the inclusion of PTFE particles during the plating process as part of the standard chemistry for this coating. The strings plated using the ultra-fine round diamond composite electroless plating bath provided a feel very similar to uncoated strings, a benefit to some players that do not care for the “slippery” feeling of some coated strings on the market today.

Step 115 comprises further comprising polishing the coated musical instrument string. Polishing minimizes residual PTFE and ultra-fine round diamond.

The ability to use a wide variety of alloys for metallization as well as a wide variety of options for the articulate matter, superior coatings for durability, feel, corrosion and oxidation protection as well as anti-frictional and aesthetic characteristics may be formulated to meet a variety of musical instrument string requirements, as demonstrated using the Surface Technology, Inc. coatings.

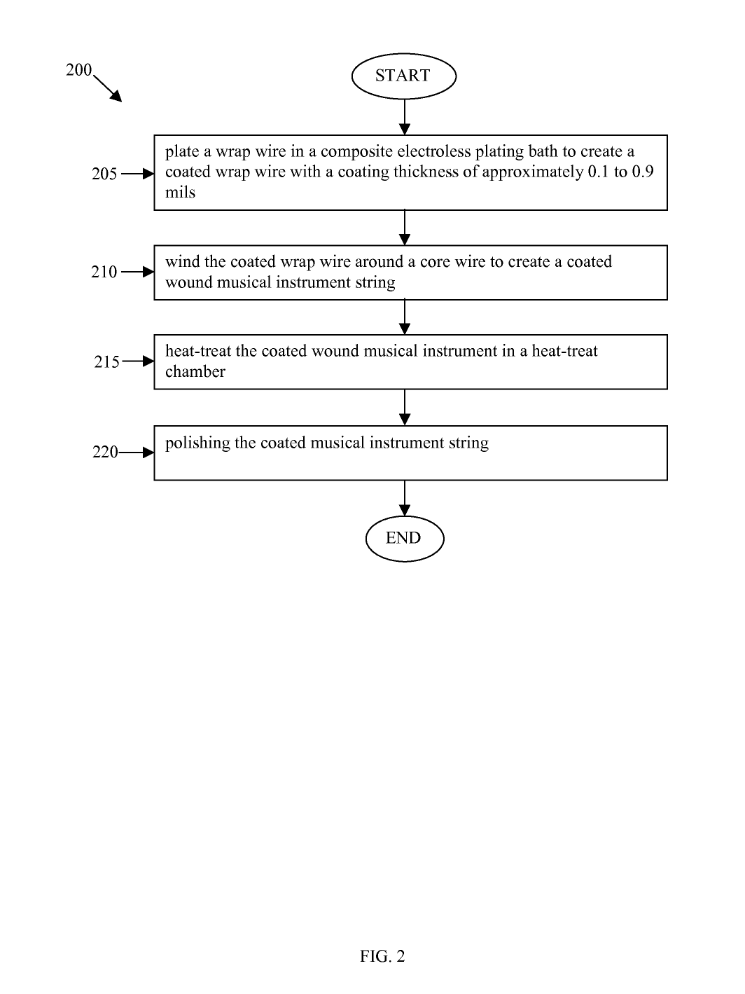

FIG. 2 shows a method for making a coated wound musical instrument string. This embodiment allows for plating at least a portion of a wrap wire in a composite electroless plating bath to create a coated wrap wire with a coating thickness of approximately 0.1 to 0.9 mils, winding the coated wrap wire around a musical instrument string, then heat-treating the coated wound musical instrument string.

In this embodiment, Step 205 comprises plating a wrap wire in a composite electroless plating bath to create a coated wrap wire with a coating thickness of approximately 0.1 to 0.9 mils. In some embodiments, the wrap wire is selected from the group consisting of a copper alloy and a steel alloy. Typically, the entire wrap wire is coated as playing of the musical instrument string occurs in the wrap wire region.

Step 210 comprises winding the coated wrap wire around a core wire to create a wound musical instrument string. In some embodiments, the core wire comprises a core wire selected from the group consisting of a copper alloy and a steel alloy.

Step 215 comprises heat-treating the wound musical instrument string in a heat-treat chamber as previously described.

In some embodiments, there is a step 220 comprising polishing the coated musical instrument string. Polishing minimizes residual PTFE and ultra-fine round diamond.

These descriptions and drawings are embodiments and teachings of the present invention.

The process will work well with many wires and almost all, if not all musical instrument strings will benefit from this invention, including wires pre-coated with tin, nickel and other coatings. The process includes electroless plating of individual musical instrument strings, longer lengths of musical instrument string that is subsequently cut into individual musical instrument strings of a suitable length for the respective musical instrument, and said plating may be accomplished by batch plating processes or continual “reel to reel” type plating as it is known by those skilled in the art. All variations are within the spirit and scope of the present invention. This disclosure is not to be considered as limiting the present invention to only the embodiments illustrated.

What is claimed is:

1) A method for making a coated musical instrument string comprising:
plating at least a portion of a musical instrument string in a composite electroless plating bath for a specified bath time to create a coated musical instrument string.

2) The method of claim 1 further comprising heat-treating at least a portion of the coated musical instrument string in a heat-treat chamber of approximately 250 degrees C. for approximately one hour.

3) The method of claim 1 further comprising polishing the coated musical instrument string.

4) The method of claim 1 wherein the musical instrument string comprises plain wire selected of the group consisting a copper alloy wire and a steel alloy wire.

5) The method of claim 1 wherein the musical instrument string comprises wound musical instrument string.

6) The method of claim 5 wherein the wound musical instrument string comprises a steel core wire.

7) The method of claim 5 wherein the wound musical instrument string comprises a wrap wire selected from the group consisting of a copper alloy and a steel alloy.

8) The method of claim 1 wherein the composite electroless plating bath comprises ultra-fine polytetrafluoroethylene (PTFE).

9) The method of claim 1 wherein the composite electroless plating bath comprises diamond.

10) The method of claim 1 wherein the composite electroless plating bath comprises nickel.

11) The method of claim 1 wherein the composite electroless plating bath comprises cobalt.

12) The method of claim 1 wherein the specified bath time ranges from approximately 15 to approximately 50 minutes.

13) The method of claim 8 wherein the composite electroless plating bath is adapted for plating an article at a rate of about 15 to 20 microns per hour.

14) The method of claim 1 wherein the composite electroless plating bath comprises a complexing agent.

15) The method of claim 1 wherein the composite electroless plating bath comprises a particulate matter stabilizer.

16) A coated wound musical instrument string comprising:
a wound musical instrument string, and
a composite electroless coating applied to at least a portion of the wound musical instrument string comprising an alloy of nickel and a particulate matter selected from the group consisting of polytetrafluoroethylene particles and diamond particles.

17) The coated wound musical instrument string of claim 16 wherein the composite electroless coating comprises an ultra-fine polytetrafluoroethylene content of approximately 20% to 25% by weight.

18) The coated wound musical instrument string of claim 16 wherein the composite electroless coating comprises diamond.

19) The coated wound musical instrument string of claim 16 wherein the composite electroless coating has a specified thickness of approximately between 0.1 to 0.9 mils.

20) The coated wound musical instrument string of claim 16 wherein the composite electroless coating further comprises cobalt.

21) A method for making a coated wound musical instrument string comprising:
plating at least a portion of a wrap wire in a composite electroless plating bath to create a coated wrap wire with a coating thickness of approximately 0.1 to 0.9 mils,
winding the coated wrap wire around a core wire to create a coated wound musical instrument string, and
heat-treating the coated wound musical instrument string in a heat-treat chamber.

22) The method of claim 21 further comprising polishing the coated wound musical instrument string.
